(19) United States
(12) Patent Application Publication
(10) Pub. No.: US 2025/0125402 A1
(43) Pub. Date: Apr. 17, 2025

(54) METHOD OF PRODUCING LAMINATE-TYPE BATTERY, AND LAMINATE-TYPE BATTERY

(71) Applicant: TOYOTA JIDOSHA KABUSHIKI KAISHA, Toyota-shi (JP)

(72) Inventors: Yusuke IKEDA, Miyoshi-shi (JP); Kenichi KAKISHITA, Nagoya-shi (JP); Tomofumi HIRUKAWA, Miyoshi-shi (JP); Masashi UEDA, Toyota-shi (JP); Shinji KOJIMA, Nagoya-shi (JP); Masataka OGUSHI, Nisshin-shi (JP); Kosuke YONEKAWA, Nisshin-shi (JP)

(21) Appl. No.: 18/822,299

(22) Filed: Sep. 2, 2024

(30) Foreign Application Priority Data
Oct. 11, 2023 (JP) 2023-176342

(51) Int. Cl. H01M 10/04; H01M 50/103; H01M 50/176; H01M 50/557

(52) U.S. Cl. CPC H01M 10/049; H01M 50/103; H01M 50/176; H01M 50/557

(57) ABSTRACT

A method of manufacturing a laminate-type battery is disclosed. The battery includes an electrode body, a side member disposed at a side face of the electrode body, and a laminate film covering the electrode body and a part of the side member, the side member being disposed at a position that is offset to a first side in a longitudinal direction of the side face relative to a center of the side face in the longitudinal direction. The method includes welding the laminate film so as to cover the electrode body and a part of the side member. The side member is shaped such that a thickness of the side member in a transverse direction of the side face increases continuously towards the first side.

### CROSS-REFERENCE TO RELATED APPLICATION

This application is based on and claims priority under 35 USC 119 from Japanese Patent Application No. 2023-176342, filed on Oct. 11, 2023, the entire disclosure of which is incorporated by reference herein.

### BACKGROUND

### Technical Field

The present disclosure relates to a method of producing a laminate-type battery, and to a laminate-type battery.

### Related Art

Conventionally, laminate-type batteries that include an electrode body, a side member such as a terminal, and a laminate film covering the electrode body and a part of the side member, have been used. In this laminate-type battery, in some cases, the side member is arranged at a position that is offset towards one side with respect to the center of a side surface in the longitudinal direction of the side surface.

For example, Japanese Patent Application Laid-open (JP-A) No. H11-283611 discloses a battery in which a terminal at one side surface is arranged so as to be offset toward one side with respect to the center on the side surface.

However, when the laminate film is welded to the electrode body in which the side member is arranged so as to be offset to one side on the side surface, in the laminate film in the region contacting the side member, there have been cases in which there are differences in thickness depending on the location.

### SUMMARY

The present disclosure provides a method of producing a laminate-type battery, which is capable of suppressing the occurrence of differences in thickness depending on the position in a laminate film after welding that is contacting a side member, and a laminate-type battery in which differences in thickness depending on the position in a laminate film that is contacting a side member, are suppressed.

The present disclosure includes the following aspects.

A first aspect of the present disclosure is a method of manufacturing a laminate-type battery, the battery including: an electrode body; a side member disposed at a side face of the electrode body; and a laminate film covering the electrode body and a part of the side member, the side member being disposed at a position that is offset to a first side in a longitudinal direction of the side face relative to a center of the side face in the longitudinal direction, the method including: welding the laminate film so as to cover the electrode body and a part of the side member, the side member being shaped such that a thickness of the side member in a transverse direction of the side face increases continuously towards the first side.

A second aspect of the present disclosure is the first aspect, in which: the side face has a first region that is positioned further towards the first side than the side member and at which the side member is not disposed, and a second region that is positioned further towards a second side than the side member, the second side being an opposite side from the first side, and at which the side member is not disposed, the first region has a smaller area than the second region, and in the side member, with a center of the side member in the longitudinal direction as a boundary, a region of the side member in a vicinity of the first region has a larger contact area between the side member and the electrode body than a region of the side member in a vicinity of the second region.

A third aspect of the present disclosure is a laminate-type battery, the laminate-type battery including: an electrode body; a side member disposed at a side face of the electrode body; and a laminate film covering the electrode body and a part of the side member, in which: the side member is disposed at a position that is offset to a first side relative to a center of the side face in a longitudinal direction of the side face, and the side member is shaped such that a thickness of the side member in a transverse direction of the side face increases continuously towards the first side.

A fourth aspect of the present disclosure is the third aspect, in which: the side face has a first region that is positioned further towards the first side than the side member and at which the side member is not disposed, and a second region that is positioned further towards a second side than the side member, the second side being an opposite side from the first side, and at which the side member is not disposed, the first region has a smaller area than the second region, and in the side member, with a center of the side member in the longitudinal direction as a boundary, a region of the side member in a vicinity of the first region has a larger contact area between the side member and the electrode body than a region of the side member in a vicinity of the second region.

According to the present disclosure, a method of producing a laminate-type battery, which is capable of suppressing the occurrence of differences in thickness depending on the position in a laminate film after welding contacting a side member, and a laminate-type battery in which differences in thickness depending on the position in a laminate film contacting a side member are suppressed, can be provided.

### BRIEF DESCRIPTION OF THE DRAWINGS

An exemplary embodiment of the present disclosure will be described in detail based on the following figures, wherein:

FIG. 1 schematically shows a perspective view of a laminate-type battery manufactured by the method of manufacturing a laminate-type battery according to an embodiment of the present disclosure, and an electrode body and a side member provided at a laminate-type battery according to an embodiment of the present disclosure;

FIG. 2 is a schematic side view, as viewed from a side surface direction, of a laminate-type battery manufactured by the method of manufacturing a laminate-type battery according to an embodiment of the present disclosure, and of a laminate-type battery according to an embodiment of the present disclosure;

FIG. 3 is a schematic plan view showing the relevant parts of a vehicle;

FIG. 4 is a schematic perspective view of a battery module;

FIG. 5 is a plan view showing a state in which the upper lid has been removed from the battery module; and

FIG. 6 is a schematic view of a battery cell housed in the battery module as viewed from the thickness direction.

### DETAILED DESCRIPTION

An embodiment that is an example of the present disclosure is explained. This explanation illustrates an exemplary embodiment and does not limit the scope of the invention.

Note that the term “step” is included in the present terminology not only as indicating an independent step, but also to indicate a case in which the intended action of the step is achieved even if it cannot be clearly distinguished from other steps.

### Method of Producing Laminate-Type Battery, and Laminate-Type Battery

A method of manufacturing a laminate type battery according to an embodiment of the present disclosure relates to a method of manufacturing a laminate type battery that is provided with an electrode body, a side member arranged on a side surface of the electrode body, and a laminate film covering the electrode body and a part of the side member, in which the side member is arranged at a position offset to one side with respect to the center of the side surface in the longitudinal direction of the side surface. The manufacturing method includes a step of welding a laminate film so as to cover the electrode body and a part of the side member. Further, the side member has a shape such that the thickness thereof continuously increases on progression toward the side at which the side member is arranged to be offset.

A laminate-type battery according to an embodiment of the present disclosure includes an electrode body, a side member arranged at a side surface of the electrode body, and a laminate film covering the electrode body and a part of the side member. The side member is arranged at a position offset to one side with respect to the center of the side surface in a longitudinal direction of the side surface. Further, the side member has a shape such that the thickness thereof continuously increases on progression toward the side at which the side member is arranged to be offset.

A laminate-type battery manufactured by the method of manufacturing a laminate-type battery according to an embodiment of the present disclosure and a laminate-type battery according to an embodiment of the present disclosure will be described with reference to the drawings. The drawings indicated below are schematically shown, and the sizes and shapes of the parts have been appropriately exaggerated for ease of understanding.

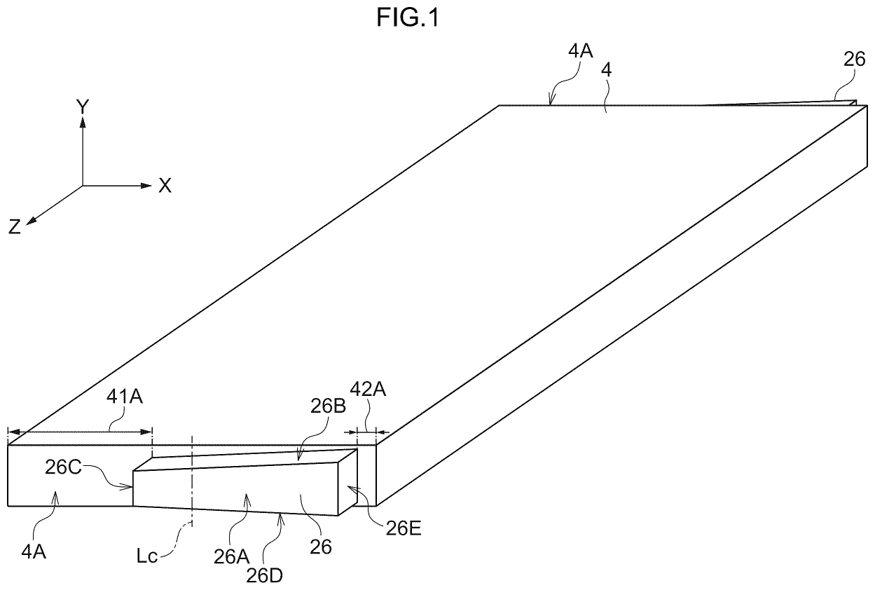

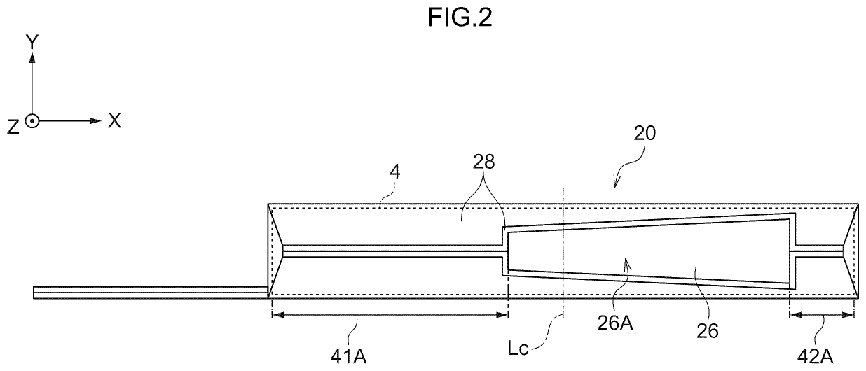

FIG. 1 is a schematic perspective view showing a laminate-type battery manufactured by the method for producing a laminate-type battery according to an embodiment of the present disclosure and an electrode body and a side member provided at the laminate-type battery according to an embodiment of the present disclosure. FIG. 2 is a schematic side view of a laminate-type battery manufactured by the method for producing a laminate-type battery according to an embodiment of the present disclosure and a laminate-type battery according to an embodiment of the present disclosure, as viewed from a side surface direction (the direction of the surface on which the side member is arranged: the Z direction in FIGS. 1 and 2).

A battery (battery cell) 20, which is an example of the laminate-type battery shown in FIGS. 1 and 2, has an electrode body 4 and terminals 26, which are examples of side members, respectively arranged on a pair of side surfaces 4A of the electrode body 4. Note that on the side surface 4A of the electrode body 4, there are two regions 41A and 42A, in which the terminal 26 is not arranged, at respective sides of the side surface 4A with the terminal 26 interposed therebetween in the longitudinal direction of the side surface 4A (the direction of arrow X).

One side in the longitudinal direction of the side surface 4A is defined as a first side, and the other side is defined as the second side. The terminal 26 is arranged at a position that is offset toward the first side with respect to the center Lc of the side surface 4A in the longitudinal direction (the direction of arrow X) of the side surface 4A of the electrode body 4 (a position offset to the right side in FIGS. 1 and 2). Therefore, on the side surface 4A of the electrode body 4, the region 42A on the first side (one example of a first region) is smaller than the region 41A on the second side (one example of a second region).

In the following description, among the two regions in which the side member is not arranged on the side surface of the electrode body, the region having a larger area is referred to as the “wide region”, and the region having a smaller area is referred to as the “narrow region”.

Furthermore, as shown in FIG. 2, the battery (battery cell) 20 includes a laminate film 28 which covers the electrode body 4 and a part of the terminal 26. The laminate film 28 covers the entire surface of the electrode body 4, and all of the areas on the side surface 4A of the electrode body 4 at which the terminal 26 is not provided are covered with the laminate film 28 (therefore, in FIG. 2, the electrode body 4 covered with the laminate film 28 is shown by a dotted line). Furthermore, the laminate film 28 is arranged to cover, with respect to the terminal 26, a part of each of the upper surface 26B, the left side surface 26C, the lower surface 26D, and the right side surface 26E, of the terminal 26, and more specifically, regions of these four surfaces at the side of the electrode body 4. Therefore, the entire surface of the outer surface 26A of the terminal 26 and regions of the upper surface 26B, the left side surface 26C, the lower surface 26D, and the right side surface 26E at opposite sides from the electrode body 4, are not covered by the laminate film 28, and are exposed.

Further, the terminal 26 has a configuration in which its thickness in a transverse direction (e.g., the Y direction in FIGS. 1 and 2) of the side surface 4A continuously increases toward the first side (the side at which the terminal 26 is arranged to be offset). In other words, among the two regions 41A and 42A at which the terminal 26 is not arranged on the side surface 4A of the electrode body 4, the region 41A is a larger area (wide region) and the region 42A is a smaller area (narrow region), the thickness of the terminal 26 continuously increases from the wide region side toward the narrow region side.

Conventionally, laminate-type batteries that include an electrode body, a side member such as a terminal, and a laminate film covering the electrode body and a part of the side member, have been used. In this laminate-type battery, owing to the arrangement of batteries inside the battery module and the like, side members may be arranged at positions offset to the first side with respect to the center of the side surface in the longitudinal direction of the side surface (the X direction in FIGS. 1 and 2).

In the manufacture of a laminate-type battery, when sealing the electrode body and a part of the side member with the laminate film, a step of welding the laminate film so as to cover the electrode body and a part of the side member is performed. For example, at a position where the laminate film contacts the side member, by pressing a heated welding member against the side member via the laminate film, the inner surface of the laminate film (the side contacting the side member) is melted, and the laminate film is welded to the side member.

However, when the laminate film is welded to an electrode body in which the side member is arranged offset to the first side on the side surface, in some cases, in a region of the laminate film contacting the side member, the thickness varies depending on the location. Specifically, in a region of the laminate film contacting the side member, the thickness of the laminate film has been reduced in a region close to the first side. In other words, in a region of the laminate film contacting the side member, the thickness of the laminate film has been reduced in the region close to side of the narrow region (the side of region 42A in FIGS. 1 and 2) of the side surface of the electrode body. Conversely, in a region in which the laminate film contacts the side member, the thickness of the laminate film has been increased in the region close to the second side, which is at the opposite side from the first side. In other words, in the region in which the laminate film contacts the side member, the thickness of the laminate film has been increased in the region close to the side of the wide region (the side of the region 41A in FIGS. 1 and 2) of the side surface of the electrode body.

The reason for this is presumed to be as follows.

Here, a case will be described in which the side member is arranged on the side surface of the electrode body so as to be offset toward the first side, and the shape of the side member is a rectangular parallelepiped shape (i.e., a shape in which the thickness is constant without changing toward the first side). Since heat applied to the laminate film when welding the laminate film to the side member is absorbed by the side member and/or the electrode body, not all of the heat applied contributes to the melting of the inner surface of the laminate film. In the electrode body in which the side member is arranged so as to be offset toward the first side on the side surface of the electrode body, it is thought that a difference occurs in the amount of heat absorbed by the electrode body at the first side and at the second side of the side member in the longitudinal direction of the side surface (the X direction in FIGS. 1 and 2). In other words, it is thought that on the side surface of the electrode body, the amount of heat absorbed by the electrode body when the laminate film is welded increases at the side member on the side close to the wide region, and the amount of heat absorbed by the electrode body decreases at the side member on the side close to the narrow region. This is presumed to be because the volume of the electrode body that contributes to heat absorption on the wide region side (i.e., the volume of the electrode body which is present in the vicinity of the side member on the wide region side) is larger than the volume of the electrode body that contributes to heat absorption on the narrow region side (i.e., the volume of the electrode body which is present in the vicinity of the side member on the narrow region side). Further, in the laminate film contacting the side member on the wide region side (the left side in FIGS. 1 and 2), since the amount of heat absorbed by the electrode body is large, the amount of heat contributing to melting of the inner surface of the laminate film is reduced, and by reducing the amount of melting, the thickness of the laminate film after welding increases. Further, in the laminate film contacting the side member on the narrow region side (the right side in FIGS. 1 and 2), since the amount of heat absorbed by the electrode body is small, the amount of heat that contributes to melting of the inner surface of the laminate film increases, and by increasing the amount of melting, the thickness of the laminate film after welding is reduced. It is presumed that in the laminate film after welding in the region contacting the side member, a difference in thickness occurs depending on the location in accordance with the above mechanism.

In view of the above, in the laminate-type battery according to the embodiment of the present disclosure, the shape of the side member that is arranged offset toward the first side is a shape in which the thickness continuously increases toward the first side. In other words, the shape of the side member is a shape in which the thickness continuously increases from the wide region side toward the narrow region side (the right side in FIGS. 1 and 2). As a result, while the volume of the side member itself on the wide region side (the left side in FIGS. 1 and 2) is smaller, and the area of the contact surface between the side member and the electrode body is also smaller, the volume of the side member on the narrow region side (the right side in FIGS. 1 and 2) is larger, and the area of the contact surface between the side member and the electrode body is also larger. That is, in the side member, with the center of the side member in the longitudinal direction of the side surface of the electrode as a boundary, the contact area between the side member and the electrode body is larger in the region closer to the narrow region than in the region closer to the wide region. Therefore, in the laminate film contacting the side member on the wide region side, the amount of heat absorption by the side member and the amount of heat absorption by the electrode body can be reduced. Furthermore, in the laminate film contacting the side member on the narrow region side, the amount of heat absorption by the side member and the amount of heat absorption by the electrode body can be increased. As a result, in the laminate film contacting the side member on the wide region side and the laminate film contacting the side member on the narrow region side, the amount of heat contributing to the melting of the inner surface of the laminate film during welding can be homogenized. Further, in the laminate film after welding in the region contacting the side member, it is possible to suppress occurrence of differences in thickness depending on the location.

Next, a laminate-type battery manufactured by the method for producing a laminate-type battery according to an embodiment of the present disclosure, and a battery module, a battery pack, and a vehicle having the laminate-type battery according to an embodiment of the present disclosure will be described with reference to the drawings.

### Overall Configuration of Vehicle 100

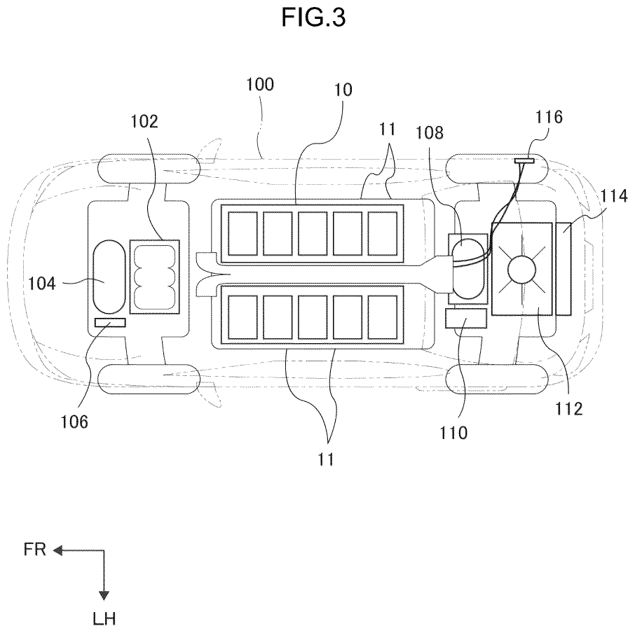

FIG. 3 is a schematic plan view showing the relevant parts of a vehicle 100 to which the battery pack 10 according to an embodiment is applied. As shown in FIG. 3, the vehicle 100 is an electric vehicle (BEV: Battery Electric Vehicle) in which the battery pack 10 is installed under the floor. Note that the arrow UP, the arrow FR, and the arrow LH in the respective drawings respectively indicate an upper side in the vehicle vertical direction, a front side in the vehicle front-rear direction, and a left side in the vehicle width direction. In the following explanation, when explanation is given using front-rear, left-right, and up-down directions, unless otherwise specified, it is assumed that front and rear in the vehicle front-rear direction, left and right in the vehicle width direction, and up and down in the vehicle vertical direction, are indicated.

As an example, in the vehicle 100 of the present embodiment, a DC/DC converter 102, an electric compressor 104, and a PTC (Positive Temperature Coefficient) heater 106 are arranged closer to the vehicle front side than the battery pack 10. Furthermore, a motor 108, a gear box 110, an inverter 112, and a charger 114 are arranged at the vehicle rear side of the battery pack 10.

The voltage of the DC current output from the battery pack 10 is adjusted by the DC/DC converter 102, and then supplied to the electric compressor 104, the PTC heater 106, the inverter 112, and the like. Furthermore, by supplying electric power to the motor 108 via the inverter 112, the rear wheel rotates to drive the vehicle 100.

A charging port 116 is provided at a right side part of the rear part of the vehicle 100, and by connecting the charging plug of an external charging facility (not shown) at the charging port 116, power can be stored in the battery pack 10 via the charger 114.

Note that the arrangement and structure of the components constituting the vehicle 100 are not limited to the configurations described above. For example, the present invention may be applied to an engine-mounted hybrid vehicle (HV: Hybrid Vehicle) or a plug-in hybrid vehicle (PHEV: Plug-in Hybrid Electric Vehicle). Furthermore, in the present embodiment, the vehicle is a rear wheel drive vehicle in which the motor 108 is installed in the rear part of the vehicle, but the present invention is not limited thereto. The vehicle may be a front wheel drive vehicle in which the motor 108 is installed in the front part of the vehicle, or a pair of motors 108 may be installed at the front and rear of the vehicle. Furthermore, the vehicle may be provided with an in-wheel motor on each wheel.

Here, the battery pack 10 is configured to include plural battery modules 11. In the present embodiment, as an example, ten battery modules 11 are provided. Specifically, five battery modules 11 are arranged in the vehicle front-rear direction on the right side of the vehicle 100, and five battery modules 11 are arranged in the vehicle front-rear direction on the left side of the vehicle 100. Furthermore, each battery module 11 is electrically connected.

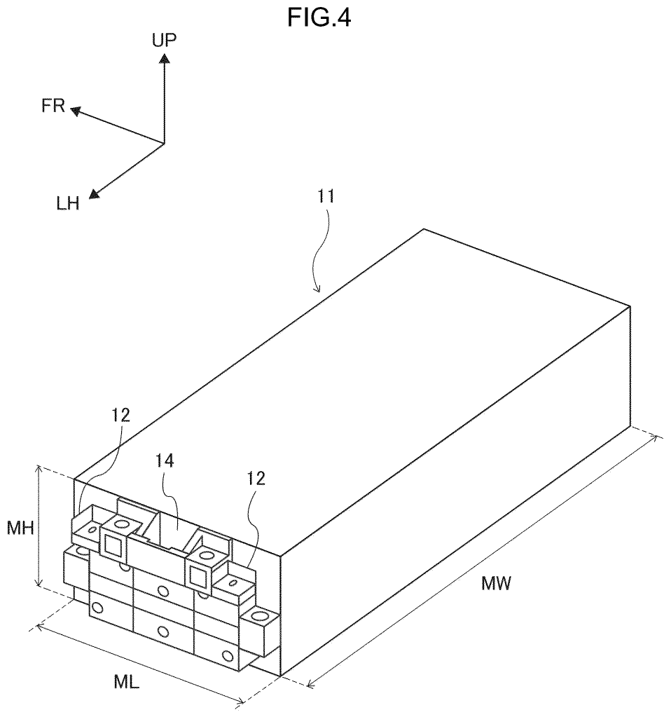

FIG. 4 is a schematic perspective view of the battery module 11. As shown in FIG. 4, the battery module 11 is formed in a substantially rectangular parallelepiped shape having the vehicle width direction as a longitudinal direction. Furthermore, the outer shell of the battery module 11 is formed of an aluminum alloy. For example, an outer shell of the battery module 11 is formed by joining die-cast aluminum to each end of an extruded material of an aluminum alloy by laser welding or the like.

A pair of voltage terminals 12 and a connector 14 are provided at each end of the battery module 11 in the vehicle width direction. A flexible printed circuit board 22, which will be described later, is connected to the connector 14. Furthermore, a bus bar (not illustrated) is welded to each end of the battery module 11 in the vehicle width direction.

The length MW of the battery module 11 in the vehicle width direction is, for example, 350 mm to 600 mm, the length ML in the vehicle front-rear direction is, for example, 150 mm to 250 mm, and the vehicle vertical height MH is, for example, 80 mm to 110 mm.

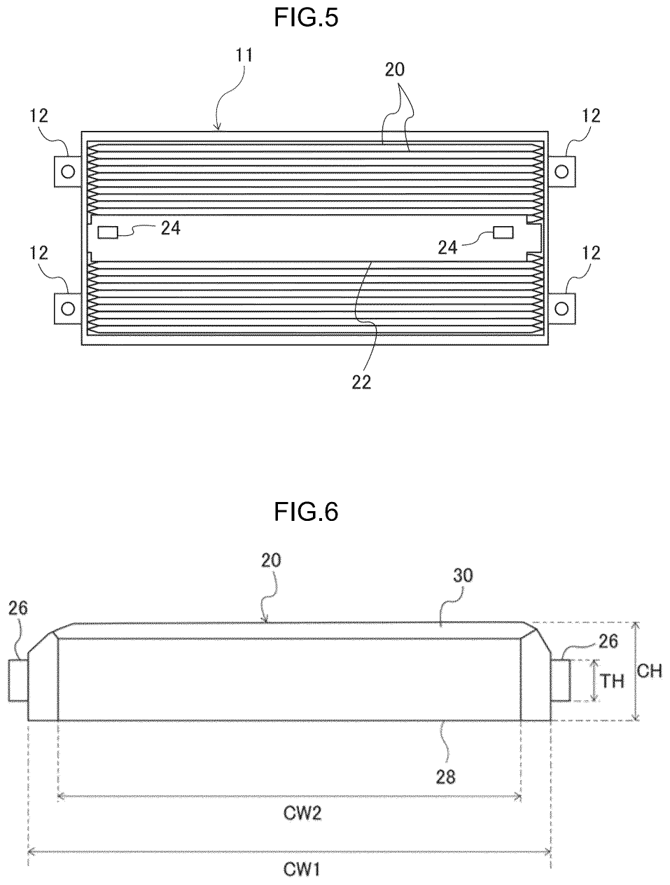

FIG. 5 is a plan view of a state in which the upper lid has been removed from the battery module 11. As shown in FIG. 5, plural battery cells 20 are housed in the interior of the battery module 11 in an arrayed state. In the present embodiment, as an example, 24 battery cells 20 are arrayed in the vehicle front-rear direction and adhered to each other.

A flexible printed circuit board (FPC: Flexible Printed Circuit) 22 is arranged on the battery cell 20. The flexible printed circuit board 22 is formed in a band shape with the vehicle width direction as the longitudinal direction, and a thermistor 24 is provided at each end of the flexible printed circuit board 22. The thermistor 24 is not adhered to the battery cell 20 and is configured to be pressed toward the battery cell 20 side by the upper lid of the battery module 11.

Furthermore, one or more cushioning materials (not illustrated) are housed inside the battery module 11. For example, the cushioning material is a thin plate-shaped member which is elastically deformable, and is arranged between adjacent battery cells 20 with the arrangement direction of the battery cells 20 as its thickness direction. In the present embodiment, as an example, cushioning materials are arranged at both end parts in the longitudinal direction of the battery module 11 and at the center part in the longitudinal direction, respectively.

FIG. 6 is a schematic view showing a battery cell 20 housed in the battery module 11 as viewed from the thickness direction. As shown in FIG. 6, the battery cell 20 is formed in a substantially rectangular plate shape, and an electrode body (not shown) is housed therein. The electrode body is configured by layering a positive electrode, a negative electrode, and a separator, and is sealed by a laminate film 28.

In the present embodiment, as an example, an embossed sheet-shaped laminate film 28 is folded and adhered to form a housing part of the electrode body. Note that although both of a single-cup embossing structure in which one location is embossed and a double-cup embossing structure in which two locations are embossed can be adopted, in the present embodiment, a single-cup embossed structure has a draw depth of about 8 mm to 10 mm.

The upper ends of both ends of the battery cell 20 in the longitudinal direction are bent, and the corners thereof form an outer shape. Furthermore, an upper end part of the battery cell 20 is bent, and a fixing tape 30 is wound onto an upper end part of the battery cell 20 along the longitudinal direction.

Here, a terminal (tab) 26 is provided at each end in the longitudinal direction of the battery cell 20. In the present embodiment, as an example, the terminal 26 is provided at a position offset downward from the center of the battery cell 20 in the vertical direction. The terminal 26 is connected to a bus bar (not illustrated) by laser welding or the like.

The length CW1 of the battery cell 20 in the vehicle width direction is, for example, 530 mm to 600 mm, 600 mm to 700 mm, 700 mm to 800 mm, 800 to 900 mm, or 1000 mm or more, and the length CW2 of the region in which the electrode body is housed is, for example, 500 mm to 520 mm, 600 mm to 700 mm, 700 mm to 800 mm, 800 to 900 mm, or 1000 mm or more. The height CH of the battery cell 20 is, for example, 80 mm to 110 mm, or 110 mm to 140 mm. Furthermore, the thickness of the battery cell 20 is 5.0 mm to 7.0 mm, 7.0 mm to 9.0 mm, or 9.0 mm to 11.0 mm, and the height TH of the terminal 26 is 40 mm to 50 mm, 50 mm to 60 mm, or 60 mm to 70 mm.

What is claimed is:

1. A method of manufacturing a laminate-type battery, the battery comprising: an electrode body; a side member disposed at a side face of the electrode body; and a laminate film covering the electrode body and a part of the side member, the side member being disposed at a position that is offset to a first side in a longitudinal direction of the side face relative to a center of the side face in the longitudinal direction, the method comprising:
welding the laminate film so as to cover the electrode body and a part of the side member,
wherein the side member is shaped such that a thickness of the side member in a transverse direction of the side face increases continuously towards the first side.

2. The method of manufacturing a laminate-type battery of claim 1, wherein:
the side face has a first region that is positioned further towards the first side than the side member and at which the side member is not disposed, and a second region that is positioned further towards a second side than the side member, the second side being an opposite side from the first side, and at which the side member is not disposed,
the first region has a smaller area than the second region, and
in the side member, with a center of the side member in the longitudinal direction as a boundary, a region of the side member in a vicinity of the first region has a larger contact area between the side member and the electrode body than a region of the side member in a vicinity of the second region.

3. A laminate-type battery, comprising:
an electrode body;
a side member disposed at a side face of the electrode body; and
a laminate film covering the electrode body and a part of the side member, wherein:
the side member is disposed at a position that is offset to a first side in a longitudinal direction of the side face relative to a center of the side face in a longitudinal direction of the side face, and
the side member is shaped such that a thickness of the side member in a transverse direction of the side face increases continuously towards the first side.

4. The laminate-type battery of claim 3, wherein:
the side face has a first region that is positioned further towards the first side than the side member and at which the side member is not disposed, and a second region that is positioned further towards a second side than the side member, the second side being an opposite side from the first side, and at which the side member is not disposed,
the first region has a smaller area than the second region, and
in the side member, with a center of the side member in the longitudinal direction as a boundary, a region of the side member in a vicinity of the first region has a larger contact area between the side member and the electrode body than a region of the side member in a vicinity of the second region.
